(19) United States
(12) Patent Application Publication
(10) Pub. No.: US 2017/0118676 A1
(43) Pub. Date: Apr. 27, 2017

(54) HIGH EFFICIENCY SIGNAL FIELD LOAD BALANCING

(71) Applicant: INTEL IP CORPORATION, SANTA CLARA, CA (US)

(72) Inventors: Qinghua Li, San Ramon, CA (US); Xiaogang Chen, Beijing (CN); Yuan Zhu, Beijing (CN); Yushu Zhang, Beijing (CN)

(21) Appl. No.: 15/084,093

(22) Filed: Mar. 29, 2016

Related U.S. Application Data
(60) Provisional application No. 62/246,831, filed on Oct. 27, 2015.

(51) Int. Cl. H04W 28/08; H04W 28/06; H04W 72/04

(52) U.S. Cl. CPC H04W 28/08; H04W 72/04; H04W 28/06

(57) ABSTRACT

This disclosure describes methods, apparatus, and systems related to a high efficiency signal field load balancing system. A device may determine one or more high efficiency signal fields of a high efficiency preamble, wherein at least one of the one or more high efficiency signal fields includes at least in part a common field and one or more user specific fields. The device may determine a resource allocation index associated with the one or more user specific fields. The device may determine a partition of the one or more user specific fields between a first subfield of the at least one of the one or more high efficiency signal fields and a second subfield of the at least one of the one or more high efficiency signal fields based at least in part on the resource allocation index. The device may cause the one or more high efficiency signal fields to be wirelessly transmitted to one or more devices over a wireless communication channel.

### CROSS-REFERENCE TO RELATED APPLICATIONS

This application claims the benefit of U.S. Provisional Application No. 62/246,831 filed Oct. 27, 2015, the disclosure of which is incorporated herein by reference as if set forth in full.

### TECHNICAL FIELD

This disclosure generally relates to systems and methods for wireless communications and, more particularly, to a high efficiency signal field load balancing in wireless communications.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation. HEW may also utilize multi-user multiple-input and multiple-output (MU-MIMO) that may allow communication with multiple users.

### BRIEF DESCRIPTION OF THE DRAWINGS

FIG. 1A depicts a network diagram illustrating an example network environment of an illustrative high efficiency signal field load balancing system, in accordance with one or more example embodiments of the present disclosure.

FIG. 1B depicts an example of a high efficiency signal field load balancing system, in accordance with one or more example embodiments of the present disclosure.

FIG. 2 depicts an example of a high efficiency signal field load balancing system, in accordance with one or more example embodiments of the present disclosure.

FIGS. 3A-3D depict tables for resource allocation (RA) indexes showing device partitioning, in accordance with one or more example embodiments of the present disclosure.

FIG. 4 depicts an illustrative schematic diagram of a high efficiency signal field load balancing system, in accordance with one or more example embodiments of the present disclosure.

FIG. 5 depicts a flow diagram of an illustrative process for an illustrative high efficiency signal field load balancing system, in accordance with one or more embodiments of the present disclosure.

FIG. 6 illustrates a functional diagram of an example communication station that may be suitable for use as a user device, in accordance with one or more example embodiments of the present disclosure.

FIG. 7 is a block diagram of an example machine upon which any of one or more techniques (e.g., methods) may be performed, in accordance with one or more embodiments of the present disclosure.

### DETAILED DESCRIPTION

Example embodiments described herein provide certain systems, methods, and devices for providing signaling information to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

During communication between two devices, one or more frames may be sent and received. These frames may include preambles, which include one or more fields (or symbols) that may be based on an IEEE 802.11 standard. In a high efficiency communication (e.g., HEW), these one or more fields may be represented by one or more OFDMA symbols.

An example of one of the one or more fields may be a high efficiency signal B (HE-SIG-B) field. The HE-SIG-B field may describe attributes of the one or more frames, such as the channel width, modulation and coding, spatial stream allocation, and whether the frame is a single- or multi-user frame. The HE-SIG-B field may include a common part and one or more user specific parts. It is understood that a user specific part refers to a device specific part. For example, the common part may be common to all scheduled user devices, and the user specific parts may be specific to each user device receiving at least one of the one or more frames. The common part includes information for all scheduled users in the current PLCP protocol data unit (PPDU), and the user specific part includes the specific information for each specific user. It is understood that PLCP stands for physical layer convergence protocol.

The HE-SIG-B in the HEW preamble may have two content channels or threads denoted by HE-SIG-B1 and HE-SIG-B2. These content channels or threads may carry the resource allocation information for multiple users. Each channel or thread may carry scheduling information for a different set of users. Each channel or thread may have its own common part and user specific part(s). The common part of the channel or thread may specify information common to all the users scheduled by the channel or thread. The user specific parts may be specific to each user. Since these content channels or threads may have the same capacity, and may start and end at the same time, it may be desired to balance the loads between them in order to minimize unfilled slots.

Example embodiments of the present disclosure relate to systems, methods, and devices for a high efficiency signal field load balancing system that determines a balancing of user specific parts of the HE-SIG-B field, such that user specific parts may be divided between HE-SIG-B1 and HE-SIG-B2 in accordance with one or more embodiments of this disclosure.

In one embodiment, one or more resource allocation (RA) indexes may be utilized to indicate the load balancing used between HE-SIG-B1 and HE-SIG-B2. The one or more RA indexes may be reserved indexes having a size of about 8-bits that may be found in the common part of the HE-SIG-B content channels. The one or more RA indexes may be set to a value that would indicate the division of the user specific parts between the two HE-SIG-B content channels (e.g., HE-SIG-B1 and HE-SIG-B2).

In one embodiment, one or more RA indexes may be allocated by the high-efficiency signal field load balancing system and may be used by a transmitting device (e.g., an access point (AP) or a user device) and a receiving device (e.g., an AP or a user device). The transmitting device may determine a division of user specific parts between HE-SIG-B1 and HE-SIG-B2, and may utilize the one or more RA indexes to indicate to the receiving device how the division between HE-SIG-B1 and HE-SIG-B2 is determined. The receiving device may then utilize the one or more RA indexes and may decode the one or more user specific parts found in HE-SIG-B1 and HE-SIG-B2 based, at least in part, on which RA index is used.

In one embodiment, the high efficiency signal field load balancing system may utilize one of the RA indexes in HE-SIG-B1 to indicate that the allocating resource unit (RU) has 484 tones (e.g., 40 MHz) with six users in total, where two of the users are allocated by HE-SIG-B1. Correspondingly, one RA index in HE-SIG-B2 may indicate that the allocating RU has 484 tones with six users in total and four of them are allocated by HE-SIG-B2. In that sense, when the receiving device receives and analyzes the RA index corresponding to HE-SIG-B1 and the RA index corresponding to HE-SIG-B2, the receiving device may determine, based at least in part on the RA indexes, the type of RU (e.g., 484 tones), the total number of users, and how the users are divided between HE-SIG-B1 and HE-SIG-B2.

The above descriptions are for purposes of illustration and are not meant to be limiting. Numerous other examples, configurations, processes, etc., may exist, some of which are described in greater detail below. Example embodiments will now be described with reference to the accompanying figures.

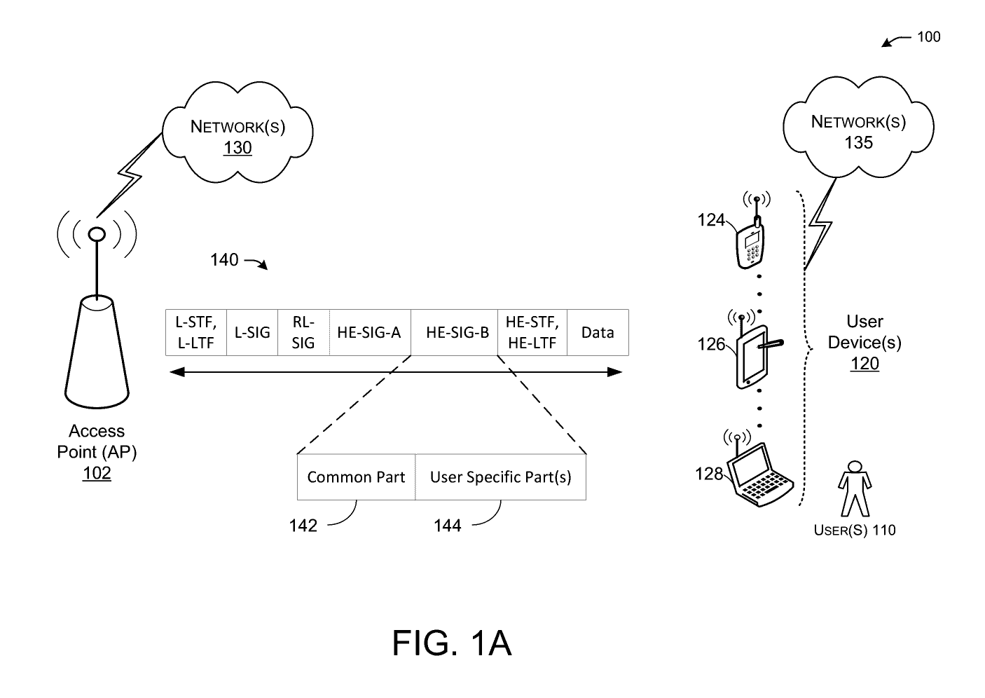

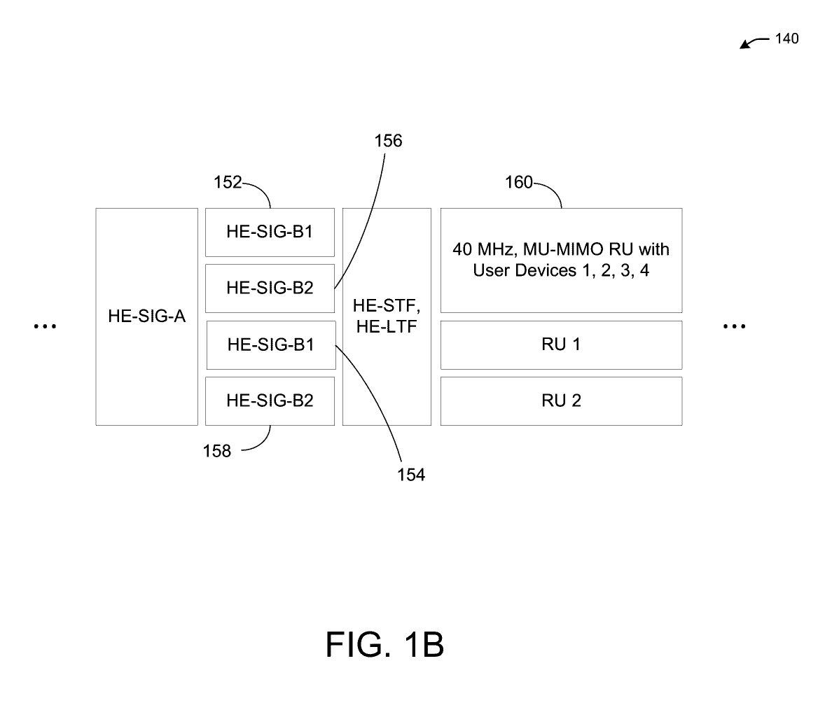

FIG. 1A depicts a network diagram illustrating an example network environment of an illustrative high efficiency signal field load balancing system, in accordance with one or more example embodiments of the present disclosure.

Wireless network 100 may include one or more user device(s) 120 and one or more access point(s) (AP) 102, which may communicate in accordance with IEEE 802.11 communication standards, including IEEE 802.11ax. The user device(s) 120 may be mobile devices that are non-stationary and do not have fixed locations.

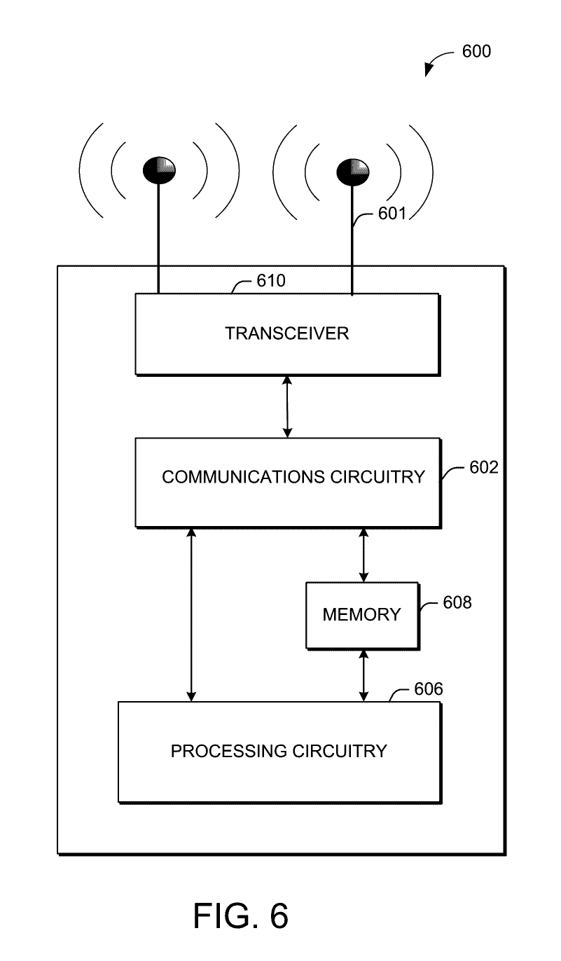

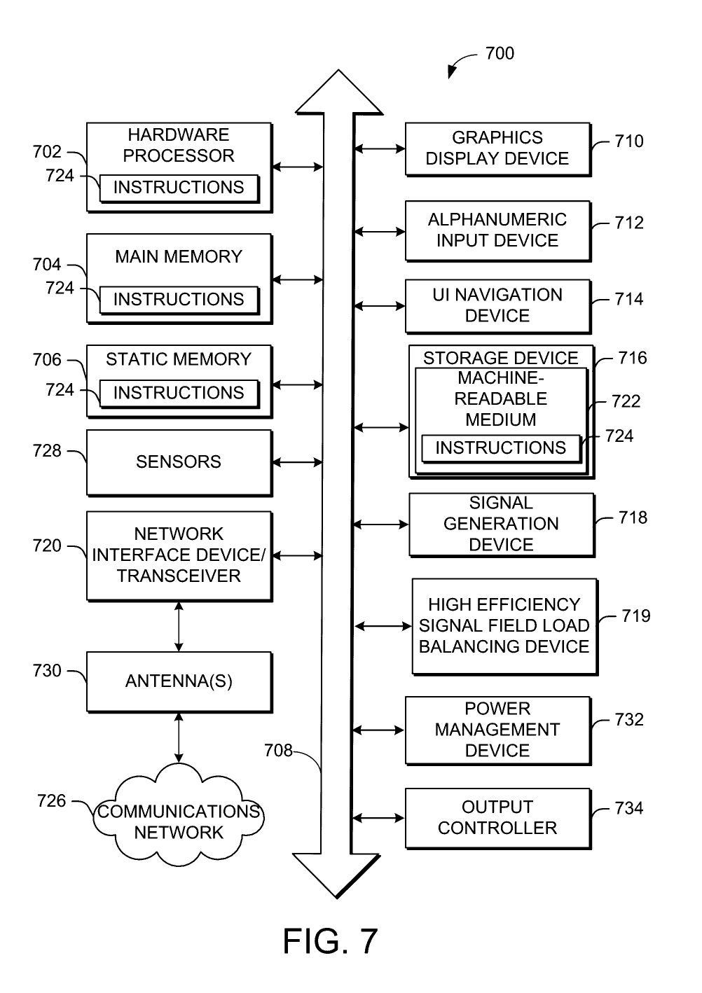

In some embodiments, the user device(s) 120 and the AP 102 may include one or more computer systems similar to that of the functional diagram of FIG. 6 and/or the example machine/system of FIG. 7.

One or more illustrative user device(s) 120 may be operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, a wearable wireless device (e.g., bracelet, watch, glasses, ring, etc.), and so forth.

Any of the user device(s) 120 (e.g., user devices 124, 126, 128), and the AP 102 may be configured to communicate with each other via one or more communications networks 130 and/or 135 wirelessly or wired. Any of the communications networks 130 and/or 135 may include, but may not be limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and the AP 102 may include one or more communications antennas. Communications antenna may be any suitable type of antenna corresponding to the communications protocols used by the user device(s) 120 (e.g., user devices 124, 126 and 128) and the AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128) and the AP 102 may include any suitable radio and/or transceiver for transmitting and/or receiving radio frequency (RF) signals in the bandwidth and/or channels corresponding to the communications protocols utilized by any of the user device(s) 120 and the AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n), 5 GHz channels (e.g., 802.11n, 802.11ac), or 60 GHZ channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

Typically, when an AP (e.g., AP 102) establishes communication with one or more user devices 120 (e.g., user devices 124, 126, and/or 128), the AP may communicate in the downlink direction by sending data frames. The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and user devices).

In one embodiment, and with reference to FIG. 1A, an HEW preamble (e.g., preamble 140) may include one or more fields, such as legacy short training (L-STF) and legacy long training (L-LTF) fields, a legacy signal field (L-SIG), a repeated legacy signal field (R-L-SIG), a high efficiency SIGNAL A (HE-SIG-A) field, a high efficiency SIGNAL B (HE-SIG-B) field, high efficiency short training (HE-STF) and high efficiency long training (HE-LTF) fields, and data. The HE-SIG-B field may describe the attributes of the one or more frames, such as the channel width, modulation and coding, spatial stream allocation, and whether the frame is a single- or multi-user frame. The HE-SIG-B field may have one or two channels or threads. Each channel or thread may include a common part 142 and one or more user specific parts 144. For example, the common part may be common to all user devices scheduled by the channel or thread, and the user specific parts may be specific to each user device receiving at least one of the one or more frames. It is understood that the above acronyms may be different and should not be construed as a limitation because other acronyms may be used for the fields included in an HEW preamble.

The one or more RA indexes may be set to a value that would indicate the division of the user specific parts between the two HE-SIG-B content channels (e.g., HE-SIG-B1 and HE-SIG-B2).

During data communication between a transmitting device and multiple receiving devices, the transmitting device may select the number of spatial streams that may be used for transmitting data to each receiving device. Each receiving device may be associated with one user. The transmitting device may also determine the number of user specific parts that may be associated with the data to be transmitted. Based at least in part on the number of users and the number of streams, the transmitting device may determine a spatial configuration field that is associated with the spatial streams used by one or more user devices. The spatial configuration field may be encoded by the transmitting device in order to notify the receiving device of how the spatial streams are used, to allow the receiving device to determine how the spatial streams were selected by the transmitting device when transmitting the data. For example, if there are two user devices, and three spatial streams are used to transmit data, the transmitting device may configure the spatial configuration field to indicate that the first user device is utilizing the first two streams and the second user device is utilizing the last one stream. It is understood that the transmitting device may select various values for the spatial configuration field to indicate various setups for utilizing the spatial streams when transmitting data. However, this may not be enough to determine which load-balancing configuration is utilized by the transmitting device.

In one embodiment, one or more indexes in the resource allocation (RA) indexes in the common part of the HE-SIG-B content channels may be used to indicate the division of user specific parts between the two HE-SIG-B content channels. The one or more RA indexes may be set to a value that would indicate the division of the user specific parts between the two HE-SIG-B content channels (e.g., HE-SIG-B1 and HE-SIG-B2). For example, one of the RA indexes in HE-SIG-B1 may indicate that the allocating resource unit (RU) has 484 tones; for example, the allocating RU has 40 MHz with six users in total, and two of them are allocated by HE-SIG-B1. Correspondingly, one RA index in HE-SIG-B2 may indicate that the allocating RU has 484 tones with six users in total, and four of them are being allocated by HE-SIG-B2.

FIG. 1B depicts an example of a high efficiency signal field load balancing system, in accordance with one or more example embodiments of the present disclosure.

In FIG. 1B, there is shown a high efficiency preamble (e.g., preamble 140). The high efficiency preamble may include various fields. In particular, the high efficiency preamble may include an HE-SIG-B field. The HE-SIG-B in the high efficiency preamble may have two content channels or threads denoted by HE-SIG-B1 (e.g., HE-SIG-B1 152 and 154) and HE-SIG-B2 (e.g., HE-SIG-B2 156 and 158). In the case of MU-MIMO, there may be more than one user device being addressed in the preamble. The content channels or threads may carry the resource allocation information for multiple users (e.g., user devices 1, 2, 3, and 4). The resource units may be utilized by the receiving devices (e.g., user devices 1, 2, 3, and 4) in order to send their uplink data to the AP 102 or other user devices 120. As shown in FIG. 1B, resource unit 160 may be utilized by user devices 1, 2, 3, and 4, while RU 1 and RU 2 may not be utilized by any of the user devices or may be used by other user devices.

HE-SIG-B1 (e.g., HE-SIG-B1 152 and 154) and HE-SIG-B2 (e.g., HE-SIG-B2 156 and 158) may have the same capacity and may start and end at the same time. Further, HE-SIG-B1 and HE-SIG-B2 may be repeated within the allocated channel. For example, HE-SIG-B1 152 may be repeated as HE-SIG-B1 154. Similarly, HE-SIG-B2 156 may be repeated as HE-SIG-B2 158. HE-SIG-B1 152 and HE-SIG-B2 156 may both include user specific parts associated with user devices 1, 2, 3, and 4. Consequently, it may be desired to balance the loads of the user specific parts between HE-SIG-B1 and HE-SIG-B2 in order to minimize the unfilled slots.

In one embodiment, the user specific parts may be load balanced between HE-SIG-B1 and HE-SIG-B2 such that the user specific parts that may be included in both HE-SIG-B1 and HE-SIG-B2 may be partitioned, split or divided such that to minimize any unfilled slots inside HE-SIG-B1 and HE-SIG-B2. It is understood that the above descriptions are for purposes of illustration and are not meant to be limiting.

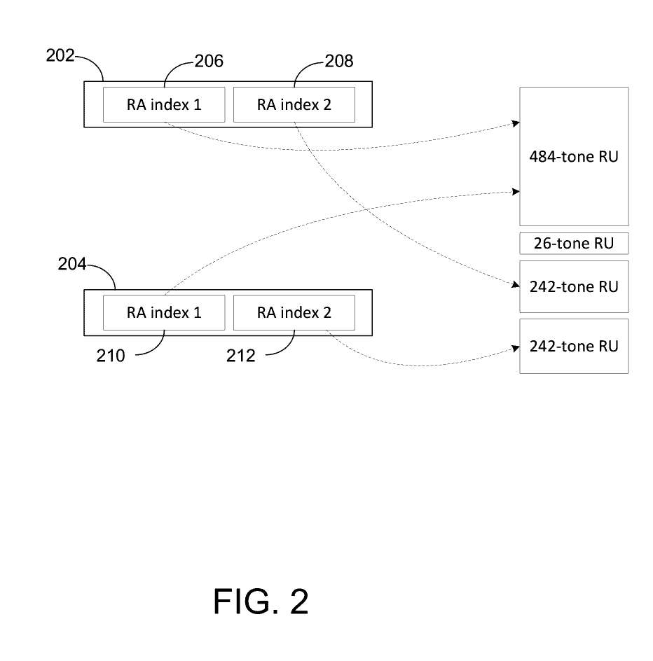

FIG. 2 depicts an example of a high efficiency signal field load balancing system, in accordance with one or more example embodiments of the present disclosure.

HE-SIG-B may be divided into two channels or threads for 40/80/160 MHz channels. The two channels or threads may be denoted as HE-SIG-B1 and HE-SIG-B2. Each thread may have its own common part (e.g., common parts 202 and 204). For example, HE-SIG-B1 may include a common part 202 and HE-SIG-B2 may include a common part 204. In addition, each thread may include a set of user specific parts (not shown here). The common part may specify how the frequency band is divided into resource units (RUs) and how many devices are in each RU.

In one embodiment, the user specific parts of the user devices may be split and allocated into the two threads based at least in part on the resource allocation (RA) indexes found in the common parts of the respective thread. That is, based on an RA index value, a certain number of user specific parts of the user devices in an RU (e.g., 484-tone RU or 996-tone RU) may be specified in HE-SIG-B1 and the rest may be specified in HE-SIG-B2. For example, if there are five user specific parts for five user devices (e.g., user devices 120 of FIG. 1A), there may be three user specific parts in HE-SIG-B1 and two user specific parts in HE-SIG-B2 based on the value of the RA index.

The example of FIG. 2 shows an 80 MHz frequency band allocation. There may be four RA indexes for an 80 MHz channel. The RA index may be about 8-bits in length. There may be an RA index for each 20 MHz subband in the common part of HE-SIG-B1 and HE-SIG-B2. HE-SIG-B1 may have some RA indexes (e.g. two 8-bit indexes), and HE-SIG-B2 may have the rest. For example, RA index 206 and RA index 208 may be included in common part 202, and RA index 210 and RA index 212 may be included in common part 204. The 484-tone RU may be a 40 MHz RU, which may be allocated for multiuser MIMO (MU-MIMO) communications, where multiple user devices may be addressed by an AP in a single communication. Typically, all of the multiuser MIMO (MU-MIMO) user devices of one RU are specified in only one HE-SIG-B thread (either HE-SIG-B1 or HE-SIG-B2). However, a high efficiency SIGNAL field load balancing system may utilize RA indexes of HE-SIG-B1 and HE-SIG-B2 in order to specify the user specific parts that may be included in HE-SIG-B1 and HE-SIG-B2 respectively. It is understood that the above descriptions are for purposes of illustration and are not meant to be limiting.

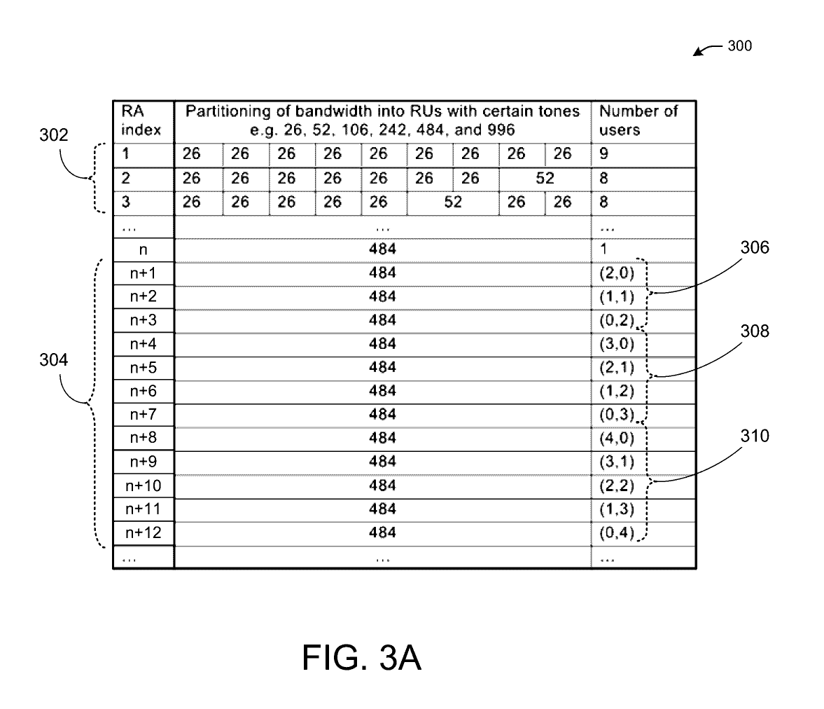

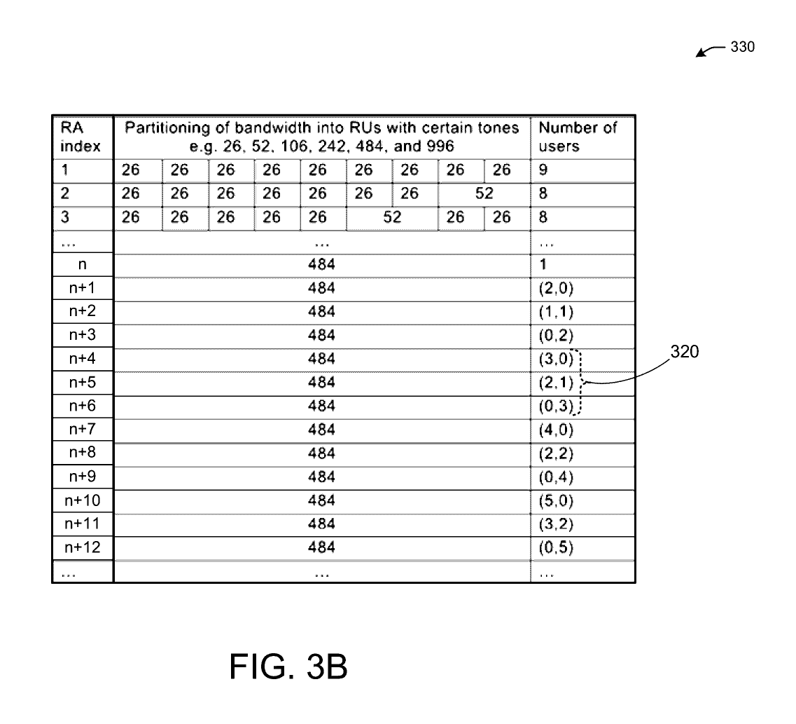

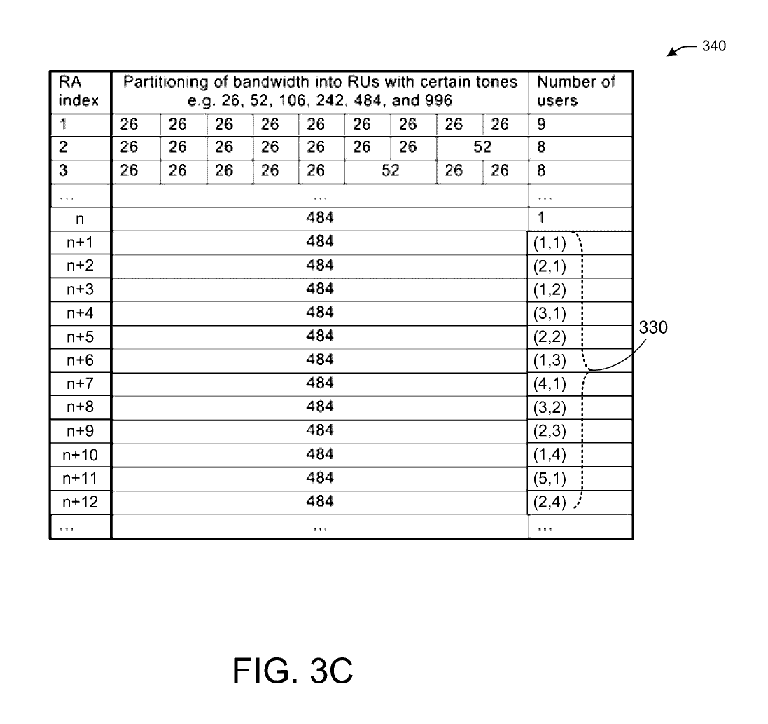

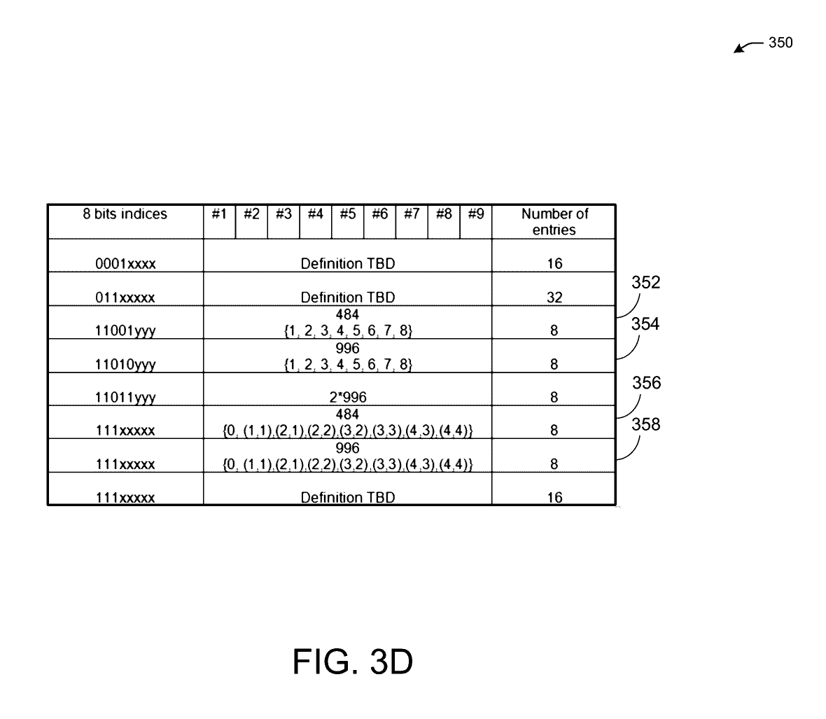

FIGS. 3A-3C depict tables for an RA index showing device partitioning, in accordance with one or more example embodiments of the present disclosure.

Referring to FIG. 3A, the RA index may have indexes of 1-3 (e.g., rows 302), where the total number of the users in the subband (e.g., 20 MHz) is specified on the right most column of the table of FIG. 3A. In one embodiment, user partitioning may be added into the lower portion of the table in FIG. 3A (e.g., rows 304). For example, RA indexes (n+1)-(n+12) may be added. A pair (i, j) may indicate that i users are allocated by HE-SIG-B1 and j users are allocated by HE-SIG-B2 for the same 484-tone RU, whose total number of users are K=i+j. Since the MU-MIMO supports up to eight users, 42 indexes may be needed to specify all the user partitions for the 484-tone RU. Similarly, another 42 indexes may be needed for the 996-tone RU. However, there are about 80 indexes left unused in the existing RA index table.

In one embodiment, in the high efficiency signal field load balancing system's one or more partitions may be determined based at least in part on a division of the number of user parts between HE-SIG-B1 and HE-SIG-B2. The high efficiency signal field load balancing system may determine that one or more user partitions may be less useful than others based on the load balancing. For example, one or more partitions may include a partition that divides the user specific parts such that all the user specific parts may be found in either HE-SIG-B1 or HE-SIG-B2. In another example, the high efficiency signal field load balancing system may determine that half of the user specific parts may be in HE-SIG-B1 and the other half in HE-SIG-B2. In yet another example, the high efficiency signal field load balancing system may determine to load balance the user specific parts based at least in part on having a difference of plus or minus one between HE-SIG-B1 and HE-SIG-B2. In other words, the partitions may be (K,0), (0,K),

$$( ⌊ \frac{K}{2} ⌋ , ⌈ \frac{K}{2} ⌉ ) , ( ⌈ \frac{K}{2} ⌉ , ⌊ \frac{K}{2} ⌋ ) , and ( ⌊ \frac{K}{2} ⌋ + m , ⌈ \frac{K}{2} ⌉ - m ) ,$$

where K is the total number of users in the 484-tone or 996-tone RU; and m=0, ±1. The partitions (K,0) and (0,K) load all the users in either the HE-SIG-B1 or HE-SIG-B2 thread. The partitions

$$( ⌊ \frac{K}{2} ⌋ , ⌈ \frac{K}{2} ⌉ ) , ( ⌈ \frac{K}{2} ⌉ , ⌊ \frac{K}{2} ⌋ ) ,$$

for example, (2,2), (2,3), (3,2), (3,3), (4,3), (3,4), may permit loading the users into the two HE-SIG-B threads such that the one thread may have at most one more user than the other. If only (K,0), (0,K),

$$( ⌊ \frac{K}{2} ⌋ , ⌈ \frac{K}{2} ⌉ ) , ( ⌈ \frac{K}{2} ⌉ , ⌊ \frac{K}{2} ⌋ )$$

are used, 24 indexes may be needed for a 484-tone RU and a 996-tone RU, respectively.

As shown in FIG. 3A, group 306 shows user specific part partitioning between HE-SIG-B1 and HE-SIG-B2 when only two user specific parts are split between HE-SIG-B1 and HE-SIG-B2 (e.g., (2, 0), (1, 1) or (0, 2)). The division may be two user specific parts on HE-SIG-B1 and zero user specific parts on HE-SIG-B2 (e.g., (2, 0)) (or vice versa) and one user specific part on HE-SIG-B1 and one user specific part on HE-SIG-B2 (e.g., (1, 1)). Similarly, groups 308 and 310, show the partitioning when there are three user specific parts and four user specific parts respectively. For example, index n+5 shows that the three user specific parts are split such that two user specific parts are on HE-SIG-B1 and one user specific part is on HE-SIG-B2 (e.g., (2, 1)). It is understood that the above descriptions are for purposes of illustration and are not meant to be limiting.

Referring to FIG. 3B, there is shown an RA index table 330 showing user device partitioning based at least in part on having the user specific parts divided between HE-SIG-B1 and HE-SIG-B2 such that the user specific parts may include (0,K), (K,0) and either

$$( ⌈ \frac{K}{2} ⌉ , ⌊ \frac{K}{2} ⌋ ) or ( ⌊ \frac{K}{2} ⌋ , ⌈ \frac{K}{2} ⌉ )$$

may be kept but not both for odd numbers of K as illustrated in the table of FIG. 3B. For example, group 320 shows partitions when three user specific parts exist. In that case, the pairs may include (3,0), (0, 3) and either (1,2) or (2,1) but not both. In that case, 21 indexes are used for the 484-tone and 996-tone RUs, respectively. Therefore, the user partitions may fit into the unused 80 indexes and still may have 38 unused indexes for other uses.

Referring to FIG. 3C, there is shown another example of an RA index table 340 for reducing the indexes used for user device partitioning. The high efficiency signal field load balancing system may be configured to remove some or all user partitions that are not load balanced; that is, removing pairs (K,0) and (0,K) and keeping the other pairs as shown in group 330. For example, if there are three user specific parts, then the pairs may include (2,1), (1,2) but does not include (3,0) or (0,3). It is understood that the above examples in FIGS. 3A-3C are for purposes of illustration and are not meant to be limiting.

Referring to FIG. 3D, there is shown another RA index table 350 as an example for using additional RA indexes to determine user partitioning.

In a typical RA index table, there may be 8 indexes for 484-tone RU (e.g., and 8 indexes for 996-tone RU, respectively, as shown in rows 352 and 354. in some embodiments, these indexes may be used to indicate that no load balancing between HE-SIG-B1 and HE-SIG-B2. That is where one channel or thread (e.g. HE-SIG-B1 or HE-SIG-B2) takes all the user specific parts. For example, when HE-SIG-B1 takes all 3 users for a 484-tone RU, the RA index corresponding to the 484-RU inside HE-SIG-B1 may use the index that indicates the RU has 484 tones and all 3 users are allocated by HE-SIG-B1 (e.g. using index 11001010). Correspondingly, the RA index corresponding to the 484-RU inside HE-SIG-B2 may use the index that indicates the RU has 484 tones and 0 user is allocated by HE-SIG-B2 (e.g. using index 11001000 that corresponds to the upper red 0). The added indexes for load balancing cases are for either

$$( ⌈ \frac{K}{2} ⌉ , ⌊ \frac{K}{2} ⌋ ) or ( ⌊ \frac{K}{2} ⌋ , ⌈ \frac{K}{2} ⌉ ) .$$

Therefore, indexes for 484-tone RU and 996-tone RU may be added, respectively, as shown by rows 356 and 358. Therefore, 16 indexes may be needed for the cases where HE-SIG-B load-balancing is desired. For example, in case of a 484-tone RU, as shown in row 356, if there are 4 user specific parts and 2 user specific parts are in HE-SIG-B1 and 2 user specific parts are in HE-SIG-B2, then one of the RA indexes of 111xxxxx, where x is either a 0 or a 1, may be used to indicate the partition used (e.g., (2, 2)). Similarly, if a 996-tone RU is used, as shown in row 358, another RA index of 111xxxxx may be used to indicate the partition used between HE-SIG-B1 and HE-SIG-B2.

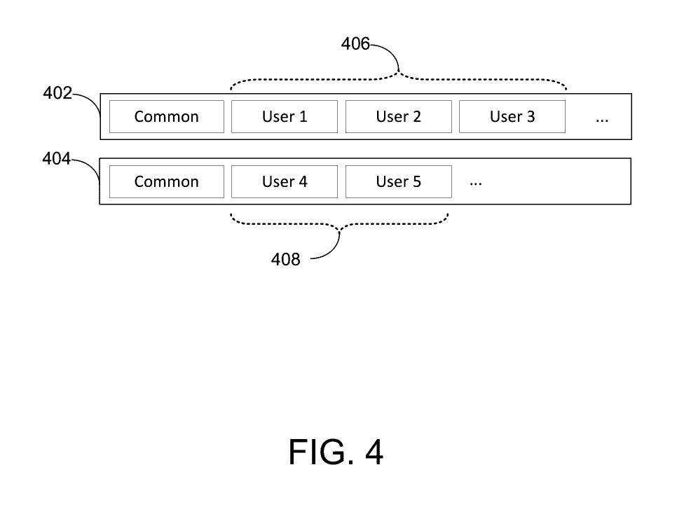

FIG. 4 depicts an illustrative schematic diagram of a high efficiency signal field load balancing system, in accordance with one or more example embodiments of the present disclosure.

In one embodiment, to reduce the indexing bits for spatial stream indication in the user specific part, the MU-MIMO users may be sorted by their numbers of allocated streams in increasing or decreasing order (e.g. (3,2,1,1,1) and (1,1,1,2,3) for five users with 1, 2, and 3 streams). That is, in this example, there are five user devices (users 1, 2, 3, 4 and 5), and each user device has a specific number of streams that may be used to communicate with an AP for example. After the user specific parts are sorted, by the order of their streams, user specific parts may be loaded to HE-SIG-B1 402 and HE-SIG-B2 404 according to the selected user partition. For example, if the selected user partition is (3,2), that is user group 406 (having three users) goes to HE-SIG-B1 402 and user group 408 (having two users) goes to HE-SIG-B2 404, and the sorted users have (3,2,1,1,1) streams. The first three users with (3,2,1) streams may go to HE-SIG-B1 and the last two users with (1,1) streams may go to HE-SIG-B2. In the common parts of both HE-SIG-B1 and HE-SIG-B2, the user partition (3,2) is indicated by the RA indexes, for example, as shown in the table of FIG. 4. After decoding either HE-SIG-B1 or HE-SIG-B2, the receiving device may know how many users are specified in the decoded thread and can sequentially locate the user specific parts of the thread.

In one embodiment, the existing stream indication in the user specific part may indicate the stream allocation of all users. For example, an index may indicate the combination of (3, 2, 1, 1, 1), such that user 1 has three streams, user 2 has two streams, user 3 has one stream, user 4 has one stream, and user 5 has one stream. The stream indication may be distributed in tables according to the total number of the MU-MIMO users denoted by K. For example, there may be index tables for K=2,3,4,5,6,7, and 8, respectively. After decoding the RA index, each user may know the user partition (i, j) and may use the stream indication table for i+j users. The first i users in HE-SIG-B1 may have the first stream numbers in the indicated combination, for example, (3,2,1) in the (3,2,1,1,1) sequence and the last j users in HE-SIG-B2 may have the last stream numbers, for example, (1,1) in the (3,2,1,1,1) sequence. It is understood that the above examples are for purposes of illustration and are not meant to be limiting.

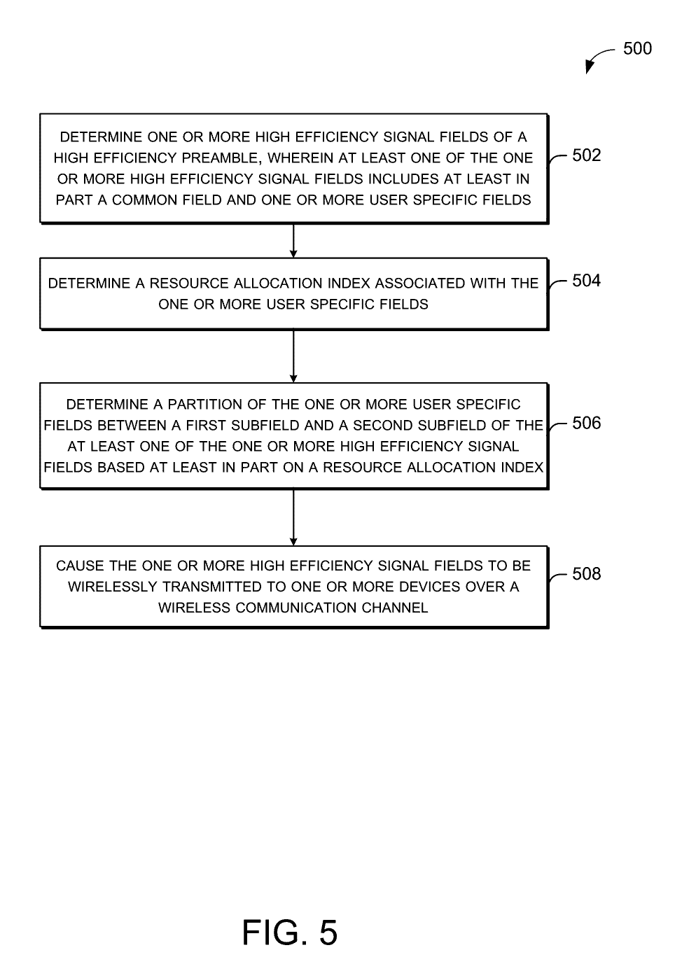

FIG. 5 illustrates a flow diagram of an illustrative process 500 for a high efficiency signal field load balancing system, in accordance with one or more example embodiments of the present disclosure.

At block 502, a device (e.g., AP 102 or user devices 120 of FIG. 1) may determine one or more high efficiency signal fields of a high efficiency preamble, wherein at least one of the one or more high efficiency signal fields includes at least in part a common field and one or more user specific fields. During communication between two devices, one or more frames may be sent and received. These frames may include preambles, which include one or more fields (or symbols) that may be based on an IEEE 802.11 standard. An example of one of the one or more fields may be a high efficiency signal B (HE-SIG-B) field. The HE-SIG-B field may describe attributes of the one or more frames, such as the channel width, modulation and coding, spatial stream allocation, and whether the frame is a single- or multi-user frame. The HE-SIG-B field may include a common part and one or more user specific parts. The common part includes information for all users in the current PLCP protocol data unit (PPDU), and the user specific part includes the specific information for each specific user. The HE-SIG-B in the HEW preamble may have two content channels or threads denoted by HE-SIG-B1 and HE-SIG-B2. These content channels or threads may carry the resource allocation information for multiple users.

At block 504, the device may determine a resource allocation index associated with the one or more user specific fields. For example, resource allocation (RA) indexes may be utilized to indicate the load balancing used between HE-SIG-B1 and HE-SIG-B2. The one or more RA indexes may be a size of about 8-bits that may be found in the common part of HE-SIG-B content channels. The one or more RA indexes may be set to a value that would indicate the division of the user specific parts between the two HE-SIG-B content channels (e.g., HE-SIG-B1 and HE-SIG-B2). It is understood that the above descriptions are for purposes of illustration and are not meant to be limiting.

At block 506, the device may determine a partition of the one or more user specific fields between a first subfield of the at least one of the one or more high efficiency signal fields and a second subfield of the at least one of the one or more high efficiency signal fields based at least in part on an RA index. That is, the one or more user specific parts that may be found in the HE-SIG-B1 field and the HE-SIG-B2 field may be allocated between these two fields in order to promote load balancing between the fields. In that sense, unfilled slots may be minimized on the HE-SIG-B1 and HE-SIG-B2 fields. For example, if there are five user specific parts, it may be determined that three user specific parts are carried by HE-SIG-B1 and two user specific parts are carried by HE-SIG-B2. This indication may be encoded in the RA index, which may be found in the common part of the HE-SIG-B fields. A receiving device (e.g., AP 102 and/or user devices 120 of FIG. 1) may then utilize the one or more RA indexes and may decode the one or more user specific parts found in HE-SIG-B1 and HE-SIG-B2 based at least in part on which RA index is used.

At block 508, the device may cause the one or more high efficiency signal fields to be wirelessly transmitted to one or more devices over a wireless communication channel.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform the operations detailed in FIGS. 1-5

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for the transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, the alphanumeric input device 712, and the UI navigation device 714 may be a touch screen display. The machine 700 may additionally include a storage device (i.e., drive unit) 716, a signal generation device 718 (e.g., a speaker), a high efficiency signal field load balancing device 719, a network interface device/transceiver 720 coupled to the antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The high efficiency signal field load balancing device 719 may carry out or perform any of the operations and processes (e.g., process 500) described and shown above. For example, the high efficiency signal field load balancing device 719 may be configured to utilize one or more resource allocation (RA) indexes to indicate the load balancing used between HE-SIG-B1 and HE-SIG-B2. The one or more RA indexes may be reserved indexes having a size of about 8-bits that may be found in the common part of HE-SIG-B content channels. The one or more RA indexes may be set to a value that would indicate the division of the user specific parts between the two HE-SIG-B content channels (e.g., HE-SIG-B1 and HE-SIG-B2).

The high efficiency signal field load balancing device 719 may be configured to allocate the one or more RA indexes, such that the one or more RA indexes may be used by a transmitting device and a receiving device. The transmitting device may determine a division of user specific parts between HE-SIG-B1 and HE-SIG-B2, and may utilize the one or more RA indexes to indicate to the receiving device how the division between HE-SIG-B1 and HE-SIG-B2 is determined. The receiving device may then utilize the one or more RA indexes and may decode the one or more user specific parts found in HE-SIG-B1 and HE-SIG-B2 based at least in part on which RA index is used.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone service (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., process 500) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions; and at least one processor configured to access the at least one memory, wherein the at least one processor is configured to execute the computer-executable instructions to determine one or more high efficiency signal fields of a high efficiency preamble, wherein at least one of the one or more high efficiency signal fields includes at least in part a common field and one or more user specific fields. The at least one processor is further configured to execute the computer-executable instructions to determine a resource allocation index associated with the one or more user specific fields. The at least one processor is further configured to execute the computer-executable instructions to determine a partition of the one or more user specific fields between a first subfield of the at least one of the one or more high efficiency signal fields and a second subfield of the at least one of the one or more high efficiency signal fields based at least in part on the resource allocation index. The at least one processor is further configured to execute the computer-executable instructions to cause the one or more high efficiency signal fields to be wirelessly transmitted to one or more devices over a wireless communication channel.

The implementations may include one or more of the following features. The instructions to determine a partition of the one or more user specific fields may further include instructions to set the resource allocation index to indicate the partition of the one or more user specific fields. The one or more high efficiency signal fields include a high efficiency signal B (HE-SIG-B) field, and wherein the first subfield is a first HE-SIG-B field and the second subfield is a second HE-SIG-B field. The at least one processor may be further configured to execute the computer-executable instructions to allocate a first number of user specific fields to the first HE-SIG-B field and a second number of user specific fields to the second HE-SIG-B field based at least in part on the resource allocation index. The common field and the user specific fields are included in the HE-SIG-B. The resource allocation index is included in the common field. The resource allocation index is associated with at least one of a 484-tone resource unit of the one or more resource units or a 996-tone resource unit of the one or more resource units. The resource allocation index is associated with one or more resource units indicating a division of a frequency band of the wireless communication channel. The device may further include a transceiver configured to transmit and receive wireless signals. The device may further include an antenna coupled to the transceiver.

According to example embodiments of the disclosure, there may be a non-transitory computer-readable medium storing computer-executable instructions which, when executed by a processor, cause the processor to perform operations. The operations may include determining one or more high efficiency signal fields of a high efficiency preamble, wherein at least one of the one or more high efficiency signal fields may include at least in part a common field and one or more user specific fields. The operations may include determining a resource allocation index associated with the one or more user specific fields. The operations may include determining a partition of the one or more user specific fields between a first subfield of the at least one of the one or more high efficiency signal fields and a second subfield of the at least one of the one or more high efficiency signal fields based at least in part on the resource allocation index. The operations may include causing the one or more high efficiency signal fields to be wirelessly transmitted to one or more devices over a wireless communication channel.

The implementations may include one or more of the following features. The computer-executable instructions cause the processor to further perform operations comprising setting the resource allocation index to indicate the partition of the one or more user specific fields. The one or more high efficiency signal fields include a high efficiency signal B (HE-SIG-B) field, and wherein the first subfield is a first HE-SIG-B field and the second subfield is a second HE-SIG-B field. The computer-executable instructions cause the processor to further perform operations comprising allocating a first number of user specific fields to the first HE-SIG-B field and a second number of user specific fields to the second HE-SIG-B field based at least in part on the resource allocation index. The common field and the user specific fields are included in the HE-SIG-B. The resource allocation index is included in the common field. The resource allocation index is associated with a 484-tone resource unit of the one or more resource units or a 996-tone resource unit of the one or more resource units.

According to example embodiments of the disclosure, there may include a method. The method may include determining, by one or more processors, one or more high efficiency signal fields of a high efficiency preamble, wherein at least one of the one or more high efficiency signal fields includes at least in part a common field and one or more user specific fields. The method may include determining, by the one or more processors, a resource allocation index associated with the one or more user specific fields. The method may include determining, by the one or more processors, a partition of the one or more user specific fields between a first subfield of the at least one of the one or more high efficiency signal fields and a second subfield of the at least one of the one or more high efficiency signal fields based at least in part on the resource allocation index. The method may include causing, by the one or more processors, the one or more high efficiency signal fields to be wirelessly transmitted to one or more devices over a wireless communication channel.

The implementations may include one or more of the following features. The method may further include setting the resource allocation index to indicate the partition of the one or more user specific fields. The one or more high efficiency signal fields include a high efficiency signal B (HE-SIG-B) field, and wherein the first subfield is a first HE-SIG-B field and the second subfield is a second HE-SIG-B field. The common field and the user specific fields are included in the HE-SIG-B. The resource allocation index is included in the common field. The resource allocation index is associated with at least one of a 484-tone resource unit of the one or more resource units or a 996-tone resource unit of the one or more resource units. The resource allocation index is associated with one or more resource units indicating a division of a frequency band of the wireless communication channel.

In example embodiments of the disclosure, there may be an apparatus. The apparatus may include means for determining, by one or more processors, one or more high efficiency signal fields of a high efficiency preamble, wherein at least one of the one or more high efficiency signal fields includes at least in part a common field and one or more user specific fields. The apparatus may include means for determining, by the one or more processors, a resource allocation index associated with the one or more user specific fields. The apparatus may include means for determining, by the one or more processors, a partition of the one or more user specific fields between a first subfield of the at least one of the one or more high efficiency signal fields and a second subfield of the at least one of the one or more high efficiency signal fields based at least in part on the resource allocation index. The apparatus may include means for causing, by the one or more processors, the one or more high efficiency signal fields to be wirelessly transmitted to one or more devices over a wireless communication channel. The implementations may include one or more of the following features. The apparatus may further include means for setting the resource allocation index to indicate the partition of the one or more user specific fields. The apparatus may further include means for allocating a first number of user specific fields to the first HE-SIG-B field and a second number of user specific fields to the second HE-SIG-B field based at least in part on the resource allocation index. The common field and the user specific fields are included in the HE-SIG-B. The resource allocation index is included in the common field. The resource allocation index is associated with a 484-tone resource unit of the one or more resource units or a 996-tone resource unit of the one or more resource units. The resource allocation index is associated with one or more resource units indicating a division of a frequency band of the wireless communication channel.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and at least one processor configured to access the at least one memory, wherein the at least one processor is configured to execute the computer-executable instructions to:
determine one or more high efficiency signal fields of a high efficiency preamble, wherein at least one of the one or more high efficiency signal fields includes at least in part a common field and one or more user specific fields;
determine a resource allocation index associated with the one or more user specific fields;
determine a partition of the one or more user specific fields between a first subfield of the at least one of the one or more high efficiency signal fields and a second subfield of the at least one of the one or more high efficiency signal fields based at least in part on the resource allocation index; and
cause the one or more high efficiency signal fields to be wirelessly transmitted to one or more devices over a wireless communication channel.

2. The device of claim 1, wherein the instructions to determine a partition of the one or more user specific fields further include instructions to set the resource allocation index to indicate the partition of the one or more user specific fields.

3. The device of claim 1, wherein the one or more high efficiency signal fields include a high efficiency signal B (HE-SIG-B) field, and wherein the first subfield is a first HE-SIG-B field and the second subfield is a second HE-SIG-B field.

4. The device of claim 3, wherein the at least one processor is further configured to execute the computer-executable instructions to allocate a first number of user specific fields to the first HE-SIG-B field and a second number of user specific fields to the second HE-SIG-B field based at least in part on the resource allocation index.

5. The device of claim 4, wherein the common field and the user specific fields are included in the HE-SIG-B.

6. The device of claim 4, wherein the resource allocation index is included in the common field.

7. The device of claim 1, wherein the resource allocation index is associated with at least one of a 484-tone resource unit of the one or more resource units or a 996-tone resource unit of the one or more resource units.

8. The device of claim 1, wherein the resource allocation index is associated with one or more resource units indicating a division of a frequency band of the wireless communication channel.

9. The device of claim 1, further comprising a transceiver configured to transmit and receive wireless signals.

10. The device of claim 9, further comprising an antenna coupled to the transceiver.

11. A non-transitory computer-readable medium storing computer-executable instructions which when executed by one or more processors result in performing operations comprising:
determining one or more high efficiency signal fields of a high efficiency preamble, wherein at least one of the one or more high efficiency signal fields includes at least in part a common field and one or more user specific fields;
determining a resource allocation index associated with the one or more user specific fields;
determining a partition of the one or more user specific fields between a first subfield of the at least one of the one or more high efficiency signal fields and a second subfield of the at least one of the one or more high efficiency signal fields based at least in part on the resource allocation index; and
causing the one or more high efficiency signal fields to be wirelessly transmitted to one or more devices over a wireless communication channel.

12. The non-transitory computer-readable medium of claim 11, wherein the computer-executable instructions cause the processor to further perform operations comprising setting the resource allocation index to indicate the partition of the one or more user specific fields.

13. The non-transitory computer-readable medium of claim 11, wherein the one or more high efficiency signal fields include a high efficiency signal B (HE-SIG-B) field, and wherein the first subfield is a first HE-SIG-B field and the second subfield is a second HE-SIG-B field.

14. The non-transitory computer-readable medium of claim 13, wherein the computer-executable instructions cause the processor to further perform operations comprising allocating a first number of user specific fields to the first HE-SIG-B field and a second number of user specific fields to the second HE-SIG-B field based at least in part on the resource allocation index.

15. The non-transitory computer-readable medium of claim 13, wherein the common field and the user specific fields are included in the HE-SIG-B.

16. The non-transitory computer-readable medium of claim 11, wherein the resource allocation index is included in the common field.

17. The non-transitory computer-readable medium of claim 11, wherein the resource allocation index is associated with a 484-tone resource unit of the one or more resource units or a 996-tone resource unit of the one or more resource units.

18. A method comprising:
determining, by one or more processors, one or more high efficiency signal fields of a high efficiency preamble, wherein at least one of the one or more high efficiency signal fields includes at least in part a common field and one or more user specific fields;
determining, by the one or more processors, a resource allocation index associated with the one or more user specific fields;
determining, by the one or more processors, a partition of the one or more user specific fields between a first subfield of the at least one of the one or more high efficiency signal fields and a second subfield of the at least one of the one or more high efficiency signal fields based at least in part on the resource allocation index; and
causing, by the one or more processors, the one or more high efficiency signal fields to be wirelessly transmitted to one or more devices over a wireless communication channel.

19. The method of claim 18, wherein the resource allocation index is associated with one or more resource units indicating a division of a frequency band of the wireless communication channel.

20. The method of claim 18, wherein the one or more high efficiency signal fields include a high efficiency signal B (HE-SIG-B) field, and wherein the first subfield is a first HE-SIG-B field and the second subfield is a second HE-SIG-B field.
